(19) United States
(12) Patent Application Publication
(10) Pub. No.: US 2006/0072753 A1
(43) Pub. Date: Apr. 6, 2006

(54) Optical signal communication apparatus

(76) Inventor: Shinji Nishimura, Koganei (JP)

Correspondence Address: REED SMITH LLP, Suite 1400, 3110 Fairview Park Drive, Falls Church, VA, 22042, US

(21) Appl. No.: 11/072,247

(22) Filed: Mar. 7, 2005

(30) Foreign Application Priority Data
Oct. 5, 2004 (JP) JP2004-292058

(51) Int. Cl. H04L 9/00

(52) U.S. Cl. 380/262

(57) ABSTRACT

In encryption transmission employing a conventional optical transmission apparatus, since a dedicated hardware unit to be used executes a complicated signal process, there are the problems that a high-speed transmission speed is difficult to realize and an entirety of a transmission system employing encryption becomes high in cost. An optical signal transmitter for encryption and an optical signal receiver for encryption, employing optical multi-value transmission which is high in cost and in which an effective improvement of transmission speed is difficult, are used only for exchanging an encryption key and data to be actually transmitted is transmitted by another line. A data signal is transmitted by using: the exchanged encryption key after communication of the encryption key is executed by using the transmitter and receiver for encryption transmission prior to the data transmission; and another system of high-speed signal transmission line in an encryption transmission circuit.

### CROSS-REFERENCE TO RELATED APPLICATION

The present application claims priority from Japanese patent application No. JP 2004-292058 filed on Oct. 5, 2004, the content of which is hereby incorporated by reference into this application.

### BACKGROUND OF THE INVENTION

The present invention relates to an internal structure of a communication apparatus for use in a computer network and particularly to a communication apparatus employing optical transmission paths.

A variety of packet exchanging apparatuses called routers and switches, etc. have widely been used for establishing communication with computer networks. Recently, in such packet exchanging apparatuses, as a transmission speed of communication is increased, optical communication employing fiber optics is frequently used instead of using conventional electric (copper) cables.

The optical communication employing the fiber optics is commonly used in a digital communication method called “PAM2”, in which one threshold is conventionally set with respect to an intensity of optical signals to be exchanged and signal communication is performed by two values of high and low levels that are defined as receiving signals with the intensities above and below the threshold, respectively. In such two-value digital signal transmission, when the communication is performed in noisy communication environments, influences of noise on the receiving signals can be reduced by classifying again the signal components into two new levels on a receiver side, whereby the signal transmission with high quality can be realized. Meanwhile, in the two-value digital signal transmission, if the high-speed signals are intended to be realized, the signals are required to be modified by far more amplitude than that of the threshold between the high and low levels during a short period. Accordingly, achieving the modulation at high speeds has been limited depending on the driving capability of an available signal modulating circuit. To realize the two-value digital signal transmission at a speed of 10 gigabits per second, for example, the signal has to modulated substantially from 0 mW to about 1 mW at about 5 pico-seconds (or vice versa) in the optical signal intensity (at this time the threshold is set to about 0.5 mW). For this reason, in order to actually realize transmission of the signal at a speed of 10 to 40 gigabits per second, measures of using high-expensive chemical compound semiconductor circuits in a laser transmitter, a photodiode receiver, and their driving circuits, which constitute a transmission apparatus system has to be taken. Also, the modulation of the optical intensity at a speed of 40 gigabits or higher per second has hardly been realized because the required modulation of the optical intensity is difficult to make due to physical limitations.

Therefore, in order to realize the signal transmission employing a low-cost semiconductor circuit made of, e.g., silicon materials and/or the transmission of the higher speed signal than that with 40 gigabits per second, it is favorable to employ a multi-value modulation transmission instead of using the conventional two-value transmission. Since the multi-value modulation is used, a smaller signal amplitude than that of the two-value modulation can be used. Therefore, loads to a laser element etc. constituting the transmission apparatus system can be reduced. (The signal modification in this case becomes a step-like signal waveform.) As a result, by the multi-value modulation method, the high-speed transmission can be realized.

As a conventional technique relating to the optical multi-value transmission, in a multi-value transmission system, such an apparatus structure has been realized that a two-value digital signal is converted into a multi-value optical signal and the multi-value optical signal is again converted into the two-value digital signal on the receiver side (for example, see Patent Document 1: Japanese Patent Laid-Open No. 8-79186).

As the conventional technique relating to the optical multi-value transmission, in another multi-value transmission system, such an apparatus structure has been conceived that the maximum amplitude value of the multi-value signals is transferred at intervals of a predetermined length of time to the receiver side (for example, see Patent Document 2: Japanese Patent Laid-Open No. 2000-349605).

As the conventional technique relating to the same optical multi-value transmission, such an apparatus structure has been realized that a plurality of independent light sources are provided and are driven in response to the multi-value optical transmission signals to control an amount of emission of light (for example, see Patent Document 3: Japanese Patent Laid-Open No. 2004-112235).

As the conventional technique relating to the same optical multi-value transmission, a technique relating to a receiver side of a multi-value transmission circuit has been conceived. This conventional technique has realized a structure in which: more signal levels in number than symbols to be transmitted are provided; at a transmission mode, the symbols to be transmitted are encoded into signal levels other than the previously encoded signal levels; and, at a reception mode, regenerative synchronizations are obtained based on differences between the received signal levels and the signal levels having been previously received and the symbols are decoded in accordance with the signal levels having been previously received (for example, see Patent Document 4: Japanese Patent Laid-Open No. 2004-80827).

As the conventional technique relating to the same optical multi-value transmission, a transmission apparatus for multiplex transmission of two or more kinds of pieces of information at intervals of small delay has been realized. In this transmission apparatus, commands and data to be inputted from other system are multiplexed by a selector of a transmitter terminal, and a multiplexed signal sequence is generated. In accordance with a predetermined encoding rule and based on the detected symbols and the amplitude values of the multi-value codes having previously been generated, an encoding part determines the amplitude values of the multi-value codes to be generated this time to generate the multi-value code sequence. A transmission part transmits the generated multi-value code sequence to a receiver terminal through a transmission line. A decoding part of the receiving terminal decodes and reproduces commands and data, from the amplitude value of the multi-value code sequence outputted from the reception section and the amplitude value of the multi-value code sequence having previously been received, in accordance with a predetermined decoding rule. The decoding part separates and outputs the commands and data (for example, see Patent Document 5: Japanese Patent Laid-Open No. 2000-4261).

As the conventional technique relating to the same optical multi-value transmission, in an optical multi-value transmission apparatus, a technique for increasing or decreasing the number of values of the optical multi-value signals depending on the length of the transmission line (for example, see Patent Document 6: Japanese Patent Laid-Open No. 8-130561).

In addition, by using an optical multi-value transmission apparatus, it is possible to expect improvement of the signal transmission speed and concurrently add a function of encryption. The function of encryption becomes very important one because the needs of improving the security of the transmission have grown. In a transmission apparatus employing the optical multi-value transmission as a conventional technique relative to the function of encryption, it has been conceived that while a relation between the transmitted signal and the noise is maintained so as to comply with a standard, a method and apparatus of provide a key distribution over a long distance are realized. A conventional technique, i.e., an encryption key distribution apparatus for providing the encryption key by using influences of noises to be subjected at the time of transmitting or receiving the signals, is characterized in that while the relation between the received signals and the noises is maintained so as to comply with the predetermined standards for the encryption measures, the transmission signals are amplified at two or more steps and the encryption key to be transmitted over a long distance is provided (for example, see Non-Patent Document 1: IEEE, Trans. on Information Theory, Vol. 49, No. 12, pp. 3312-3317, 2003). This conventional technique is of one type called quantum encryption. The quantum encryption is a signal method, which belongs to a field of perfect encryption in which logically cracking of interception is impossible, so that the communication with high secrecy can be realized by using the quantum encryption. However, in such an encryption circuit employing the multi-value transmission method, a specific encryption/decryption circuit is required, whereby the overall cost of apparatus production has been increased. Further, in this encryption circuit, when the signals are converted into multi-level values, an amplitude intensity change from the signal with small voltage amplitude to one with large voltage amplitude is required due to a demand for making the interception difficult on a logical encryption side. Therefore, the conventional multi-value transmission method loses the advantage of being cable of transmitting the signals by using the small amplitude and it is difficult to realize the high-speed signal transmission.

### SUMMARY OF THE INVENTION

A primary object to be solved by the present invention is to provide the encryption transmission employing the optical multi-value transmission, i.e., to solve the problems that the encryption transmission apparatus, which requires a dedicated hardware unit and has big limitations to the effective transmission speed due to the complicated signal processing, is manufactured at high cost in view of the entirety of the transmission system and concurrently cannot realize the high-speed communication.

Also, a secondary object of the present invention is to provide the encryption transmission apparatus employing the optical multi-value transmission, i.e., to improve the point that the signal intensity fluctuates heavily in comparison with electrical signal transmission, ensure an optional allowance for a receiver-side circuit to a satisfactory extent, and thereby realize the signal transmission with high quality.

Outlines of representative ones of the inventions made by the present inventor will be briefly described as follows.

The encryption circuit employing the optical multi-value transmission, which is manufactured at the high cost and in which the effective improvement of the transmission speed is difficult, is used only for exchanging the encryption key and the actual data to be transmitted is transmitted through another line employing the two-value digital signals. Further, since a single encryption circuit is shared with a plurality of two-value digital data lines, a ratio of the high-cost encryption circuit to the entire apparatus can be reduced in cost.

Also, the optical signal amplitude to be realized based on results obtained by executing a scramble process in the multi-value transmission is set to be equal to or more than the minimum receiver sensitivity of the receiving circuit and to be equal to or less than the minimum signal amplitude of the optical transmission-side circuit.

Effects obtained by representative ones of the inventions disclosed in the present application will be briefly described as follows.

Since the encryption circuit and the data transmission circuit are separated from each other so as to be included in different systems, the single encryption circuit can be shared with a plurality of data transmission circuits. By sharing the high-cost encryption circuit, a reduction in costs of the data transmission system can be reduced as a while.

In addition, since the intensity of the optical signal amplitude to be realized as a result of the scramble process in the multi-value transmission is set within a range defined by the apparatus parameters, the quality of the transmission system can be improved as a while.

### BRIEF DESCRIPTION OF THE DRAWINGS

FIG. 1 is a block diagram of an encryption transmission apparatus.

FIG. 2 is a diagram showing setting examples of waveform of signals on a transmitter side of the encryption transmission system.

FIG. 3 is a diagram showing observed examples of waveform of signals on a receiver side of the encryption transmission system.

FIG. 4 is a block diagram showing an apparatus obtained by combining an encryption transmission system and a two-value digital data transmission system.

FIG. 5 is a diagram showing a handshaking between a transmitter and a receiver in the apparatus obtained by the combination of the encryption transmission system and the two-value digital data transmission system.

FIG. 6 is an explanatory view for showing reference signals.

FIG. 7 is a block diagram of an encryption transmission apparatus equipped with an error detector.

FIG. 8 is a diagram showing a handshaking between the transmitter and the receiver, which is used at a time of the encryption transmission employing the reference signals.

FIG. 9 is a diagram showing an example of each value that is set in Formulas 1 and 2.

FIG. 10 is a diagram showing an intensity of signals outputted from an optical transmitter defined by Formula 3.

FIG. 11 is a view of an embodiment employing a multiple wavelength system instead of using an arrangement of a first embodiment.

FIG. 12 is a view of an embodiment employing optical switches instead of using the arrangement of the first embodiment.

### DESCRIPTION OF THE PREFERRED EMBODIMENTS

Hereinafter, embodiments of the present invention will be described with reference to the accompanying drawings. Although the following embodiments are described by using specific numeric values for easily understanding the embodiments, the numeric values are merely examples. Therefore, the present invention is not limited to those numeric values.

### First Embodiment

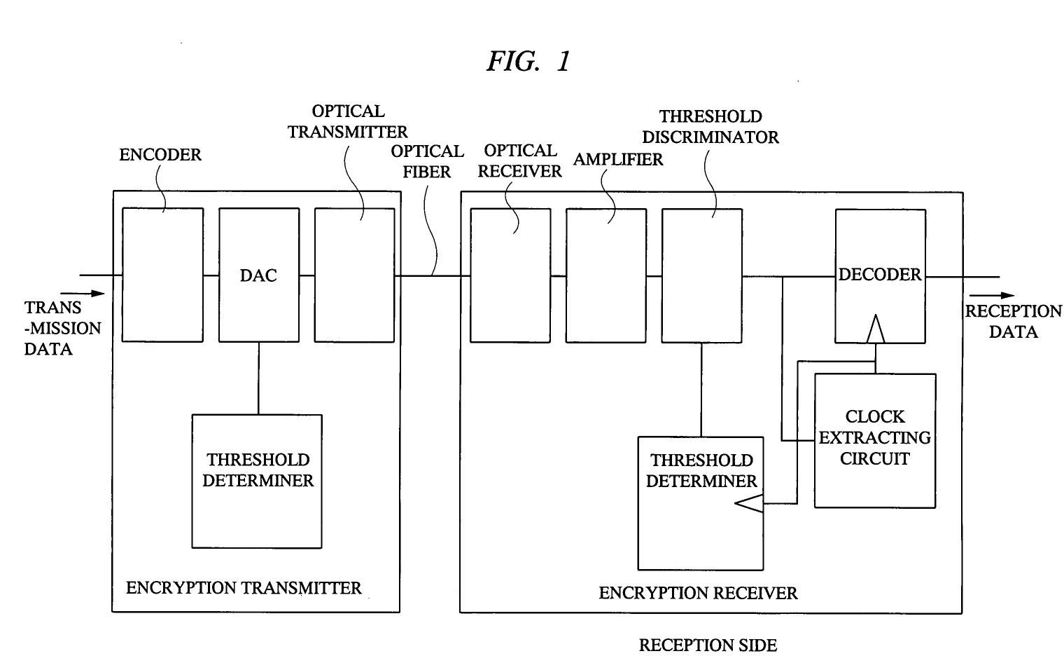

In a first embodiment, a transmitting unit and a receiving unit shown in FIG. 1 are used as an encryption transmission apparatus employing an optical multi-value transmission method. In an optical encrypted signal transmitting unit, transmission data composed of two-value digital data before encryption is converted into multi-value signals by a digital-to-analog converter (DAC) after scramble encoding is executed by an encoder. At a time of the conversion to the multi-value signals, a signal is generated in accordance with a logical threshold determiner connected to the DAC. An output from the DAC is converted into the multi-value signals at the optical transmitting unit and thereafter is sent into an optical fiber. An optical signal transmitted to the optical fiber is converted to an analog electric signal at the optical receiving unit. The electric signal from the optical receiving unit is converted to an electric signal with discriminable amplitude by an amplifier and thereafter is decoded into a two-value digital signal by a logical threshold discriminator. The logical threshold discriminator discriminates the two-value digital signal by using as a reference a logic threshold dynamically defined by the logical threshold determiner. The discriminated digital signal is outputted as a received data to the next stage after scramble codes are decoded by the decoder.

An encryption method used in the present invention is the same as one described in IEEE, Trans. on information theory, Vol. 49, No. 12, pp. 3312-3317, 2003. In the method in the present embodiment, a between-level voltage of the signal used for multi-value transmission is set to a level lower than that of shot noise accumulated in the signal at a time of passing through the optical transmitting unit and the optical receiving unit and dynamically fluctuates the logic threshold so as to be synchronized at a transmitting terminal and a receiving terminal in accordance with a rule well-known only by a transmitter and a receiver. Therefore, a reception environment with much noise can be provided to eavesdroppers who do not know the transient rule of the fluctuated logic threshold, and a good reception environment with little noise can be provided to proper receivers who know the transient rule well. Thus, since the reception environments different in level of noise can be realized depending on the eavesdroppers and the proper receivers, the eavesdroppers can decrypt only the erroneous data and the proper receivers can receive the correct signals at a time of receiving the signals with scramble codes conforming to streaming codes.

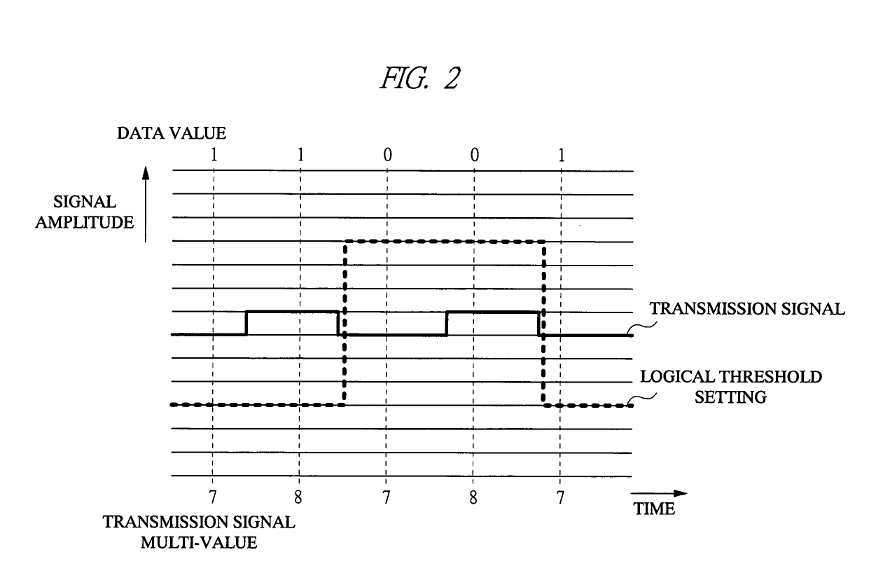

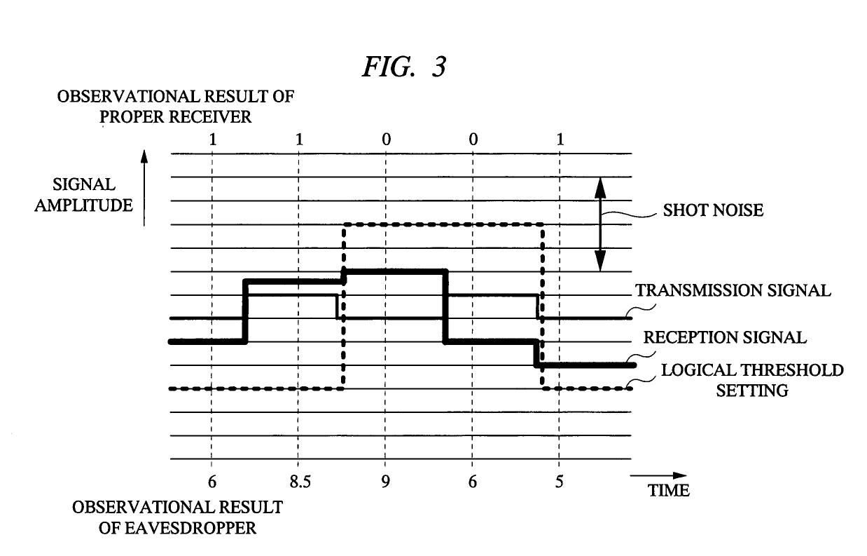

The principle of operation of encryption communication used in the present invention will be described with reference to FIGS. 2 and 3. FIG. 2 shows a signal setting of a transmitter side. It is first assumed that 5-bit continuous data, 11001, is transmitted from the transmitter side. The continuous data is transmitted by a multi-value modulation in which a signal amplitude level is divided into 14 different stages. At this time, the level of the multi-value modulation is set to have a value smaller than the distribution value of shot noise. The actual transmission signal is changed to signal levels 7, 7, 8, and 8. In contrast, a logic threshold setting is changed to signal levels 4, 4, 11, and 11. If a level relation between the actual transmission signal and the logic threshold is known, the original data value, 11001, from the transmission signal can easily be discriminated.

FIG. 3 illustrates an example of a waveform of which the signal of FIG. 2 is received through a transmission path. The reception signal is affected by shot noise (of which a distribution value is divided into four levels of the signal amplitude) and values of the reception signal have a probability distribution within a range from −2 levels to +2 levels. Due to the influence of noise, the signal is received as the multi-level modulation signal with, for example, values of 6, 8.5, 9, 6, and 5. In this case, the proper receivers, who know the logic threshold setting, can introduce the transmission data signal, 11001, on the basis of the reception signal. However, the eavesdroppers, who have no measures of knowing the logical threshold setting, must introduce the original data signal from the values of 6, 8.5, 9, 6, and 5 serving as reception signal pattern and further the reception signal pattern has no reproducibility due to the influence of noise at a time of transmitting the same pattern (namely, values of 9, 8, 5, 8, and 8 may be received at a time of another transmission). As a result, the eavesdroppers cannot receive the signal under the same qualified communication condition as that of the proper receivers (i.e., do not fail to receive the signal under the environment with a higher reception error rate), so that the environment in which eavesdropping the data is impossible can be realized.

As described with FIGS. 1 to 3, a communication line for encryption is outputted by converting two-value digital data to a multi-value signal with 14 levels. In a circuit used for the conversion to the multi-value signal with 14 levels, the circuit shown in FIG. 1 is newly needed in comparison with the case of directly outputting the two-value digital data. In addition, in order to realize the multi-value transmission with high quality, a wideband circuit with a low noise level is required, so that devices constituting the apparatus become difficult to realize and the costs of the apparatus to be realized are increased. In the communication circuit for encryption, even if such a circuit that the two-value digital signal can be transmitted at a speed of 10 gigabits per second is used, only data transmission of 100 megabits at best can be realized due to lack of band of the circuit.

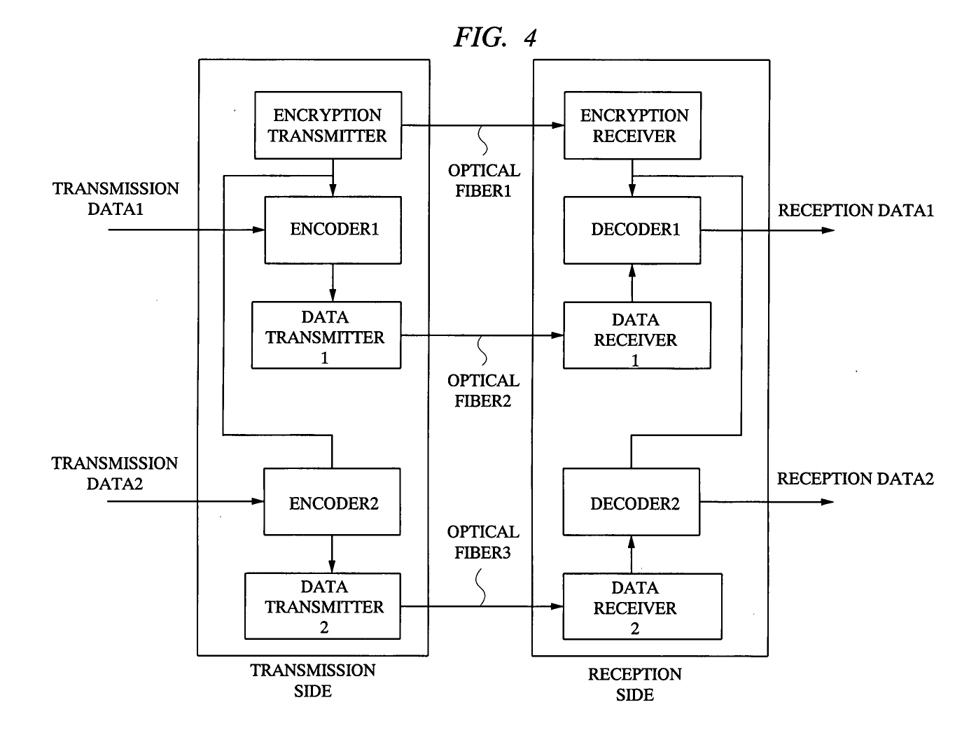

For this reason, instead of using the transmission and reception circuits for encryption to realize the data itself, an apparatus configuration shown in FIG. 4 is used to use at the same time two lines for realizing encryption communication and data communication. In the apparatus configuration shown in FIG. 4, an optical signal transmitter for encryption and an optical signal receiver for encryption are mounted as one system, whereas the data communication system is configured by two systems. In the data communication, when transmission data 1 is transmitted, only an encryption key used for communication is transmitted by using an optical fiber 1, the optical signal transmitter for encryption, and the optical signal receiver for encryption. The actual data is encrypted by the encryption key used for communicating with an encode 1, and then is transmitted by using a data transmitter 1, an optical fiber 2, and a data receiver 1, and is decoded at a decoder 1 by using the encryption key and is fetched from the reception data 1. As the data transmitter 1 and the data receiver 1, a normal two-value digital data communication apparatus is used instead of using an encryption communication apparatus. In the present invention, unrealizable data transmission at a speed of 10 gigabits per second can be realized in the encryption communication by using the two-value digital communication line. Since two two-value data communication systems share one encryption communication system, the high-speed data communication can be realized at low cost in comparison with the case of making both of an exchange of the encryption key and transmission of the actual data by using the encryption communication system.

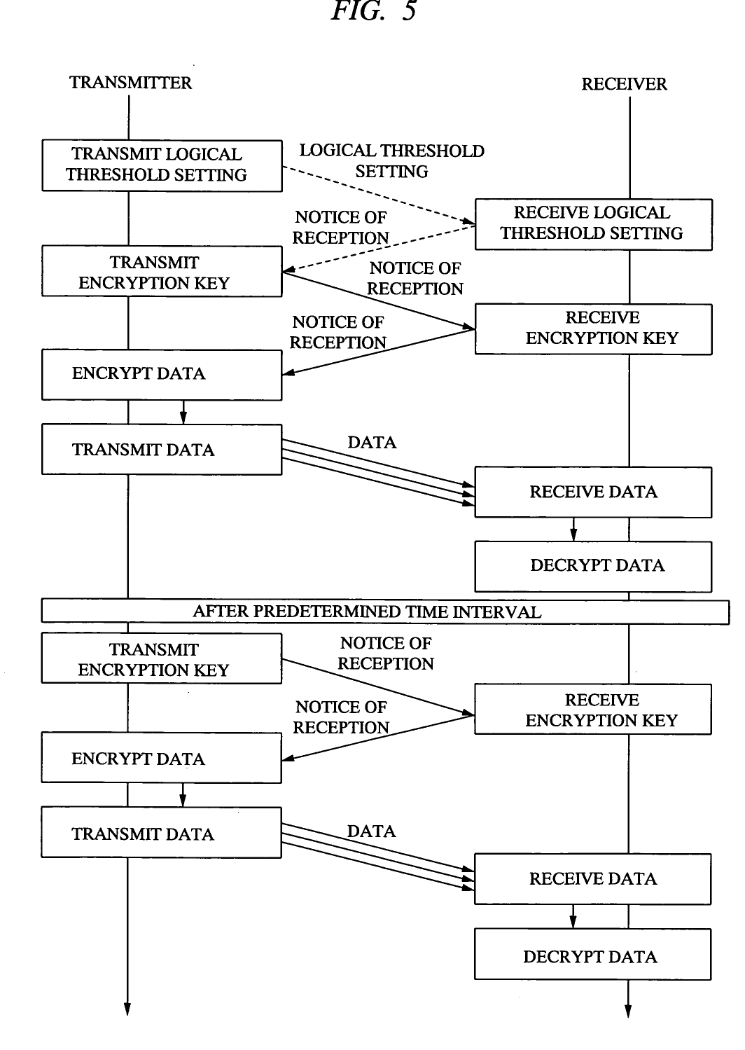

FIG. 5 illustrates a scheme of a handshaking of the actual signal transmission. First, the scheme needs to transfer the logic threshold setting from the transmitter to the receiver. However, since the transmission of the logic threshold by using the data line means to provide an opportunity for making eavesdropping of the logical threshold setting possible, the communication of the setting data by using the high-security communication path is required for transfer of the logic threshold to use an applicable high safety manner such as postal service or wire telephone service. In this embodiment, the logic threshold is transferred over the telephone line from the transmitter to the receiver which in turn issues the acknowledgment of reception before the procedure moves to the succeeding step. At the succeeding step, the encryption key is transmitted by using an encryption transmission path from the transmitter to the receiver. For transmission of the encryption key, the logic threshold determined at the preceding stage is used for dynamically varying the threshold to ensure a higher level of the secrecy. Using the encryption key, the data to be transmitted is encrypted before transmitted by using the two-value digital transmission path. When a predetermined length of time (for example, one minute) determined by the user has elapsed, the encryption key is replaced by another which is then transmitted from the transmitter to the receiver. As the encryption key is switched from one to another at intervals of the predetermined time which is commonly faster than the time required for the eavesdroppers decoding the encryption, it can hardly be disclosed to any encrypting.

### Second Embodiment

The encrypted data transmission of the first embodiment involves transmission of a multi-value transmission over the optical transmission path. This causes the signal to be varied in the amplitude by the effects of thermal condition or physical disturbance and the drift characteristics of a laser transmitter or photodiode. It is hence desired to modify the threshold at the receiver side according to the modification of the signal amplitude.

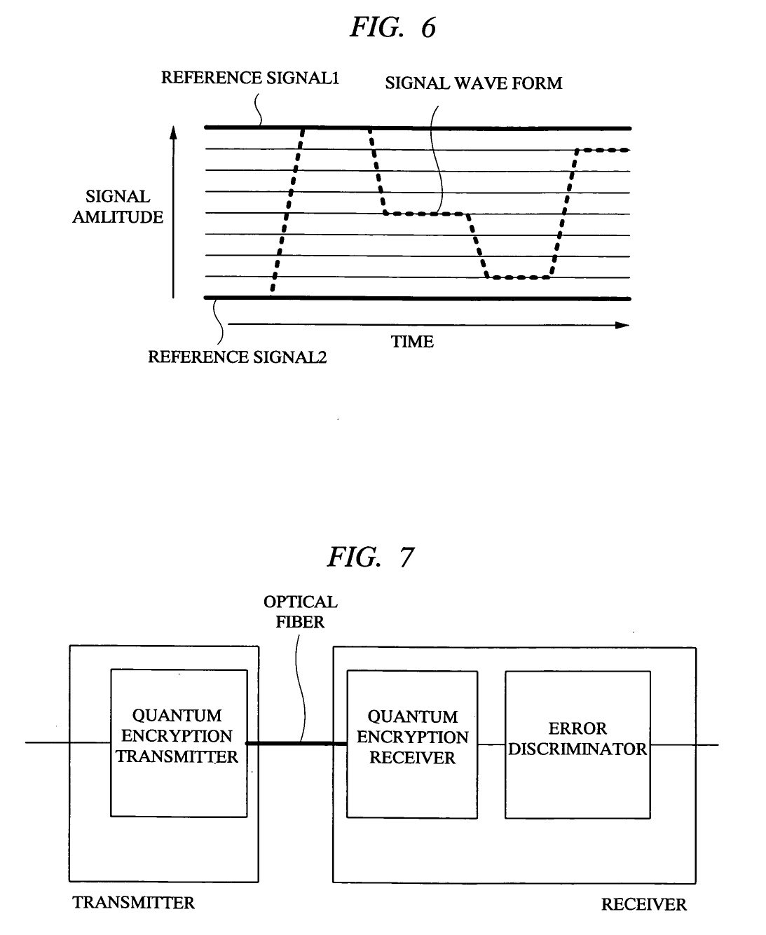

Prior to the transmission of the encrypted data, reference signals for defining the upper and lower limits of the data are determined. FIG. 6 illustrates an example of the waveform of the reference signals. Assuming that the signal level of the multi-value has 9 levels, a reference signal 1 outputs the upper limit of signal intensity level 9 while a reference signal 2 outputs the lower limit of a signal intensity level 1. The two reference signals 1 and 2 may be varied due to the effect of the modification characteristics of the transmission path before being received by the receiver. As the reference signals 1 and 2 are monitored by the receiver, the multi-value transmission signal level to be monitored can be set on the receiver side.

This embodiment has an error detector connected at the rear side of the encryption optical signal receiver as shown in FIG. 7. The error detector is arranged for, when an error is found in the decoder of the encryption optical signal receiver shown in FIG. 1, permitting the signal not to be outputted to the rear side of the detector until the error is eliminated. The error may result from injury of the optical fiber which critically declines the intensity of the optical signal and thus causes the amplitude to be hardly measured by the receiver side or thermal drift in the optical fiber which changes the intensity of the optical signal. Accordingly, the receiver may fail to receive and decode the data signal produced by the encryption rule.

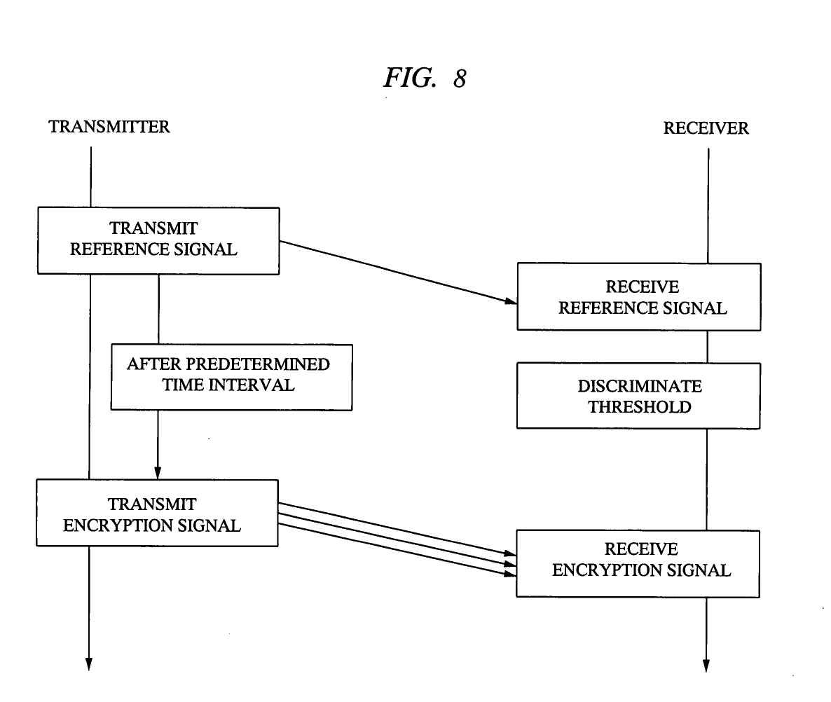

FIG. 8 illustrates a procedure for changing the reference signals from the transmitter to the receiver. Prior to the transmission of the encrypted data, the reference signals are transferred from the transmitter to the receiver which in turn examines the threshold. When a specific length of time has elapsed which is longer than the time required for examining the threshold, the encrypted data is transferred from the transmitter to the receiver. As a result, the receiver can decode the encrypted data through reviewing the logic threshold defined by the reference signals.

### Three Embodiment

The encrypt communication of the first embodiment needs to satisfy the following conditional formulas for ease of acknowledging the amplitude of the multi-value signal at the receiver (where α1, α2, α3, and α4 are coefficients not smaller than 1 or preferably equal to 1.5).
(Step value in multi-value signal)×α1<(Distribution value of shot noise in jitter component of received signal) (Formula 1).
(Distribution value of shot noise in jitter component of receiver side)×α2<(Minimum of difference between received multi-value signal and logic threshold setting value) (Formula 2).
(Maximum of amplitude change in transmitting multi-value signal)×α4<(Limit value of amplitude in transmitter side optical signal) (Formula 3).

Formula 1 expresses a condition for embodying the encrypted data transmission where the step in the multi-value signal is set smaller than (or a half of) the distribution value of shot noise. This provides every eavesdropper, who cannot obtain the setting of the logic threshold, with an eavesdropped noisy condition (where the signal can hardly be received without errors).

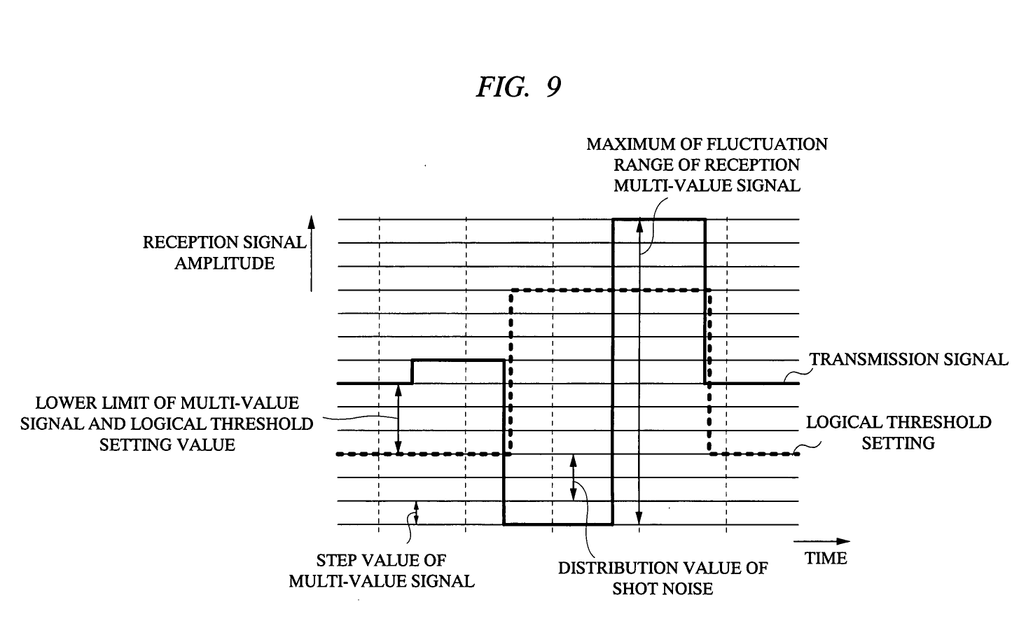

Formula 2 expresses a condition for allowing the proper receivers to receive the signal without error where the minimum or lower limit of a difference between the multi-value signal and the logic threshold setting value is greater than the distribution value of shot noise. This allows the authorized receiver, who has obtained the logic threshold, to detect data from the multi-value transmission signal without error. FIG. 9 illustrates an example of the relation in the intensity between the signals.

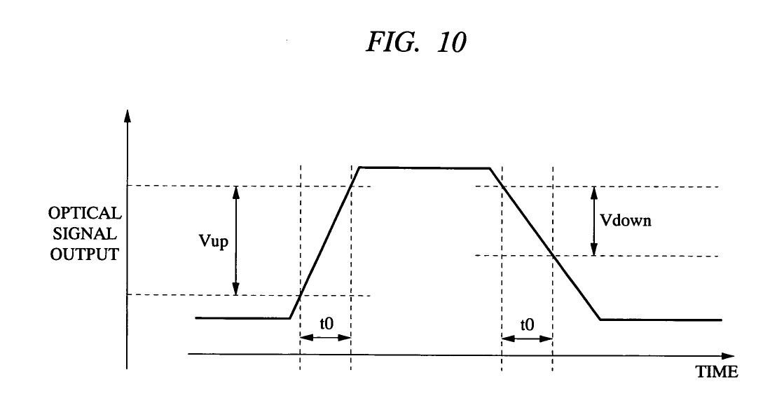

Formula 3 defines the amplitude of a laser signal of the transmitter side. It is essential that the amplitude of the encrypted data signal to be transmitted is smaller than the performance of laser defined in FIG. 10.

FIG. 10 illustrates specification method of the performance of the laser in the transmitter side. When the unit period assumed for the transmission is t1, the optical signal has to vary the intensity within to (10% of t1). It is assumed from the laser to be used can output and modify the varying range of the optical signal. The rise of the signal in the duration t0 is Vup and the decay is Vdown. In the two values, the Vup and the Vdown, the smaller is defined as amplitude limit value of the optical signal in the transmitter side expressed by Formula 3.

When the encrypted data transmission of the first embodiment is carried out under the conditions denoted by Formulas 1, 2, and 3, it can permit the proper receivers to receive the correct multi-value signal under a favorable condition while providing any eavesdroppers with an eavesdropped noisy condition.

### Fourth Embodiment

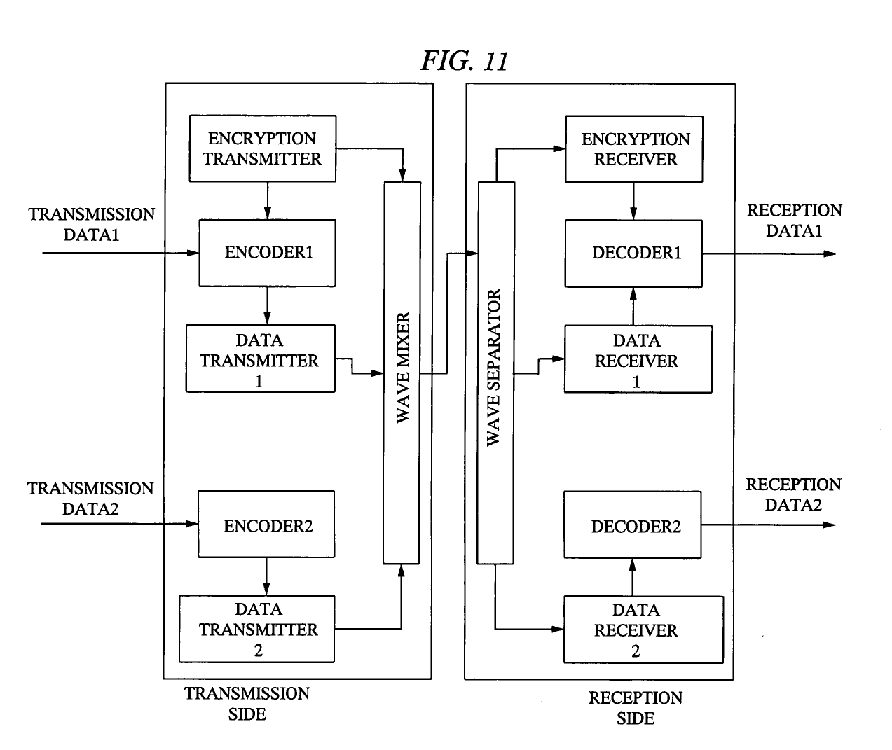

The data transmission apparatus of the first embodiment has three separate optical transmission systems to realize the signal transmission using fiber, respectively. In the embodiment shown in FIG. 11, the communication structure using three fibers are replaced by a combination of a wave mixer connected to the rear end of an optical transmitter equal to that of the first embodiment and a wave separator connected to the end of an optical receiver equal to that of the first embodiment. More specifically, the three laser emitters included in the optical transmitter of the encryption optical signal transmitter, the data transmitter 1, and the data transmitter 2 are set to different wavelengths.

This allows both the encryption communication and the two-value digital communication system to be carried out over a single fiber in a known multiple wavelength communication technique. Since this embodiment allows the overall transmission system to be structured with a single optic fiber, it can significantly be lower in the cost of fiber installation than the first embodiment particularly in the case of long distance transmission where the cost of fiber installation is crucial.

### Fifth Embodiment

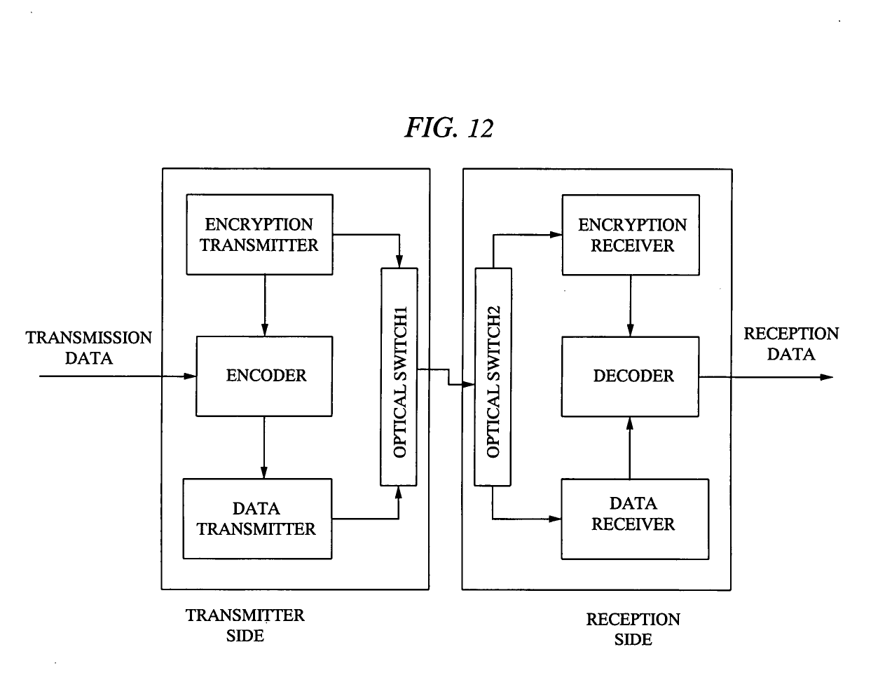

While the transmission apparatus of the first embodiment is based on one of encryption transmitter and receiver and two systems of two-value digital transmission systems, this embodiment comprises a pair of encryption signal transmitter and receiver and two systems of two-value digital transmitter system as shown in FIG. 12. Two optical switches 1 and 2 are provided in the transmitter end and the receiver end respectively for switching between the encryption transmission and the two-value data transmission. Each of the optical switches 1 and 2 has a 2:1 port arrangement for not conducting the encryption transmission and the two-value data transmission at the same time. As compared with the foregoing multiple wavelength system, the apparatus of this embodiment needs not to vary the wavelength of laser between the optical encrypted signal transmitter and the data transmitter. Also, as this embodiment employs none of the expensive wave mixer and separator, its system can further be reduced in the overall cost.

What is claimed is:

1. An optical signal communication apparatus comprising:
a first transmitter for encrypting and transmitting an encryption key for encryption transmission; and
a second transmitter for transmitting data encrypted by using said encryption key,
wherein communication using said second transmitter is temporarily stopped after a predetermined length of time has elapsed from start of the communication using said second transmitter, and the communication using said second transmitter is stared again after a new encryption key has been outputted from said first transmitter.

2. The optical signal communication apparatus according to claim 1,
wherein said first transmitter is transmittable said encryption key in multi-value transmission in which any of three or more output values is used, and
a difference in intensity between two consecutive signals of said encryption key to be transmitted in said multi-value transmission is smaller than a distribution value of shot noise in a receiver at which said encryption key is received.

3. The optical signal communication apparatus according to claim 2,
wherein said encryption key is transmitted by a signal in which any one of the three or more output values used in said multi-value transmission is assigned as a threshold, and
said threshold is a threshold common to the transmitter and the receiver for said encryption key.

4. The optical signal communication apparatus according to claim 3,
wherein said threshold is varied to any one of said three or more output values in timing common to the transmitter and the receiver for said encryption key.

5. The optical signal communication apparatus according to claim 1,
wherein said first transmitter is such that, before transmission of said encryption key, a reference signal which represents at least one of the maximum and minimum output values of the signal used for the transmission of said encryption key is transmitted, and
said reference signal is transmitted at a predetermined time interval even during the transmission of said encryption key.

6. The optical signal communication apparatus according to claim 3,
wherein a difference in intensity between said three or more output values used for said multi-value transmission is smaller than a distribution value of shot noise in a jitter component of said receiver,
a difference in the intensity between the signal used for said multi-value transmission and said threshold is greater than the distribution value of said shot noise, and
a fluctuation range of an intensity of the signal used for said multi-value transmission is smaller than the maximum amplitude of an optical signal capable of being transmitted from said first transmitter.

7. The optical signal communication apparatus according to claim 1, further comprising a wave mixer,
wherein the signal of said encryption key transmitted from said first transmitter and the signal of said encrypted data transmitted from said second transmitter are multiplexed in multiple-wavelength by said wave mixer and are transmitted to an optical transmission path common to said encryption key and said data.

8. The optical signal communication apparatus according to claim 1, further comprising an optical switch,
wherein the signal of said encryption key transmitted from said first transmitter and the signal of said encrypted data by using said encryption key transmitted from said second transmitter are switched by said optical switch and are transmitted to an optical transmission path common to said encryption key and said data.
